(19) United States
(12) Patent Application Publication
(10) Pub. No.: US 2026/0287728 A1
(43) Pub. Date: Sep. 24, 2026

(54) SYSTEM AND METHOD FOR RADAR RANGE WALK COMPENSATION IN RADAR SYSTEMS

(71) Applicant: Robert Bosch Gmbh, Gerlingen (DE)

(72) Inventors: Christopher Deng, Redondo Beach, CA (US); Murtaza Ali, Cedar Park, TX (US); Paul W. Dent, Pittsboro, NC (US); Aria Eshraghi, Austin, TX (US); Monier Maher, St. Louis, MO (US)

(21) Appl. No.: 19/700,767

(22) Filed: Jun. 8, 2026

Related U.S. Application Data
(63) Continuation of application No. 18/336,519, filed on Jun. 16, 2023, now Pat. No. 12,650,503.
(60) Provisional application No. 63/353,044, filed on Jun. 17, 2022.

(51) Int. Cl. G01S 13/32; G01S 7/02; G01S 7/35; G01S 13/34; G01S 13/58; G01S 13/931

(52) U.S. Cl. CPC G01S 13/325; G01S 7/023; G01S 7/352; G01S 7/356; G01S 13/34; G01S 13/584; G01S 13/931; G01S 2013/93271; G01S 2013/93272

(57) ABSTRACT

A radar system that uses range walk compensation to reduce system losses resulting from moving targets. During the coherent integration of pulse radar systems, the conventional Fast Fourier Transform (FFT) for Doppler processing needs to change the input range bin number in accordance with the velocity of the target. Doppler groups are configured to compute several Dopplers with one FFT. Each Doppler group has a transform Doppler that is close to the center of the group which will identify the change of range bins for the input data to the FFT. As the range bins are changed, there are two input filter techniques: nearest bin select, and 2-tap filter. After the range walk compensation process, the resultant output block has much higher coherent integration as compared to just a conventional FFT.

### CROSS REFERENCE TO RELATED APPLICATION

The present application is a continuation of U.S. patent application Ser. No. 18/336,519, filed Jun. 16, 2023, which claims the filing benefits of U.S. provisional application, Ser. No. 63/353,044, filed Jun. 17, 2022, which are hereby incorporated by reference herein in their entireties.

### FIELD OF THE INVENTION

The present invention is directed to radar systems, and more particularly to radar systems for vehicles and robotics.

### BACKGROUND OF THE INVENTION

The use of radar to determine direction, range, and velocity of objects in an environment is important in a number of applications including automotive radar, robotic sensing, and positioning. In practice, radars experience system impairments that degrade their performance.

A radar system consists of transmitters and receivers. The transmitters generate a baseband signal which is upconverted to a radio frequency (RF) signal that propagates according to an antenna pattern. The transmitted signal is reflected off of object or targets in the environment. The received signal at each receiver is the totality of the reflected signal from all targets in the environment. The receiver down converts the received signal to baseband and compares the baseband received signal to the baseband signal at one or more transmitters. This is used to determine the range, velocity, and angle of targets in the environment.

Modern pulse radars achieve coherent integration by performing a Fast Fourier Transform (FFT) along the pulse repetition interval (PRI) time dimension. This FFT exploits the Doppler Effect introduced by moving targets along the line-of-sight of the radar. However, the conventional doppler FFT approach simplifies actual physics of the moving targets. With actual physics of motion, in addition to Doppler rotation caused by radio frequency (RF) wave compression or expansion, the range of the moving target is also changing. This latter part of the actual physics is called target range walk, or range migration.

### SUMMARY OF THE INVENTION

Embodiments of the present invention provide for a radar system and associated methods that includes a technique for improving the coherent integration gain of the radar system when the target velocity is sufficiently high such that range bin migration occurs during the radar scan. By applying a prediction of the range bin migration (“range walking”) for each target Doppler, the losses of signal power as result of the range bin migration are then compensated for. An exemplary radar system uses a range walk compensation algorithm to reduce system losses resulting from moving targets. During the coherent integration of pulse radar systems, the conventional Fast Fourier Transform (FFT) for Doppler processing needs to change the input range bin number in accordance to the velocity of the target. The algorithm allows for configuration of Doppler groups to compute several Dopplers with one FFT. Each Doppler group has a transform Doppler that is close to the center of the group which will dictate the change of range bins for the input data to the FFT. As the range bins are changed, there are two input filter techniques: nearest bin select, and 2-tap filter. After range walk compensation processes all Doppler groups by FFT, the resultant output block has much higher coherent integration as compared to just a conventional FFT.

In an aspect of the present invention, the radar system includes the creation of Doppler groups where only the one Doppler frequency in that group, usually the middle one, is used as the prediction for range walking. By creating Doppler groups, the total complexity of Doppler processing with range walk compensation is reduced in accordance with the number of Doppler groups to create.

In another aspect of the present invention, a parameter labeled FWF is used to divide up the entire Doppler coverage into Doppler groups.

In yet another aspect of the present invention, the application of a range bin filter is used to combine one or more range bins into the Doppler processing. The range bin filter can be a nearest bin select method that uses just one range bin per sample of the Doppler processing vector. A 2-tap filter that combines two range bins to form one sample into the Doppler processing vector is another option. The 2-tap filter uses coefficients that are dependent on the radar modulation.

### BRIEF DESCRIPTION OF THE DRAWINGS

FIG. 1 is a plan view of an automobile equipped with a radar system in accordance with the present invention;

FIG. 2A and FIG. 2B are block diagrams of radar systems in accordance with the present invention;

FIG. 3 is a block diagram illustrating a radar with a plurality of receivers and a plurality of transmitters (MIMO radar) in accordance with the present invention;

FIGS. 4A and 4B are diagrams of an exemplary radar receiver architecture for range walk compensation in accordance with the present invention;

FIG. 5 is a diagram of an exemplary high level algorithm flow for range walk compensation with a configuration process in accordance with the present invention;

FIG. 6 is a diagram of a detailed data path flow of an exemplary range walk compensation in accordance with the present invention;

FIG. 7A is an illustration of an exemplary forming of Doppler groups for an exemplary range walk compensation in accordance with the present invention;

FIG. 7B is an illustration of an exemplary forming of Doppler groups using an exemplary FWF parameter in accordance with the present invention;

FIG. 8 is an illustration of exemplary timing controls for range walk compensation in accordance with the present invention;

FIG. 9 is a diagram of an exemplary mapping of Doppler groups to the transformed output block when there is zero doppler adjustment before the range walk compensation in accordance with the present invention;

FIG. 10 is a diagram of an exemplary mapping of Doppler groups to the transformed output block when there is non-zero doppler adjustment before the range walk compensation in accordance with the present invention;

FIG. 11 is a diagram of an exemplary practical use of the range walk compensation that provides a reduction in performance losses for an exemplary radar system in accordance with the present invention; and

FIG. 12 illustrates an exemplary timeline of a radar scan consisting of a number of pulse repetition intervals in accordance with the present invention.

### DESCRIPTION OF THE PREFERRED EMBODIMENTS

The present invention will now be described with reference to the accompanying Figures, wherein numbered elements in the following written description correspond to like-numbered elements in the Figures. All figures don't draw time, frequency, or magnitudes to scale. Accurate interpretation of scale must be derived from the equations given in this invention. As discussed herein, the exemplary radar system includes techniques and processes for improving a coherent integration gain of the radar system. As described herein, the radar system uses a range walk compensation process or algorithm to reduce system losses resulting from moving targets. During the coherent integration of pulse radar systems, the conventional Fast Fourier Transform (FFT) for Doppler processing needs to change the input range bin number in accordance to the velocity of the target. The process allows for configuration of Doppler groups to compute several Dopplers with one FFT. Each Doppler group has a transform Doppler that is close to the center of the group which will dictate the change of range bins for the input data to the FFT. As the range bins are changed, there are two input filter techniques: nearest bin select, and 2-tap filter. After range walk compensation processes all Doppler groups by FFT, the resultant output block has much higher coherent integration as compared to just a conventional FFT.

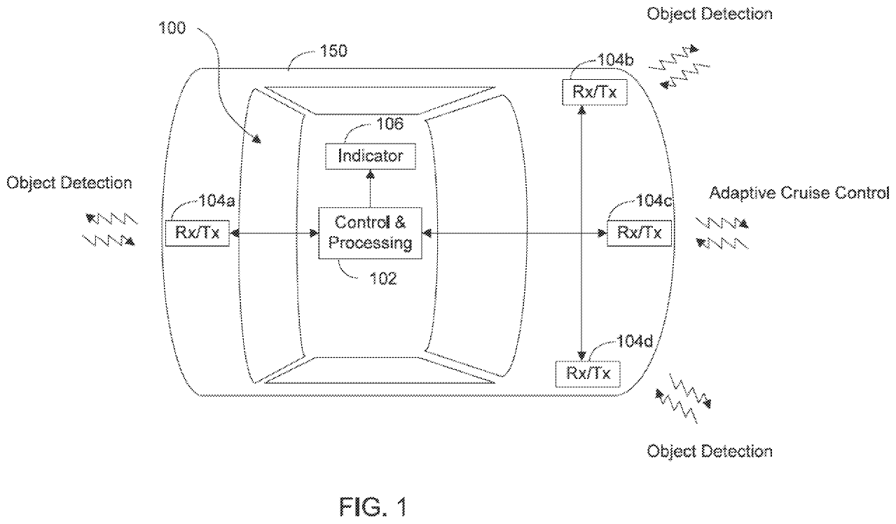

FIG. 1 illustrates an exemplary radar system 100 configured for use in a vehicle 150. The vehicle 150 may be an automobile, truck, or bus, etc. As illustrated in FIG. 1, the radar system 100 may comprise one or more transmitters and one or more virtual receivers 104a-104d. Other configurations are also possible. FIG. 1 illustrates receivers/transmitters 104a-104d placed to acquire and provide data for object detection and adaptive cruise control. The radar system 100 (providing such object detection and adaptive cruise control or the like) may be part of an Advanced Driver Assistance System (ADAS) for the automobile 150.

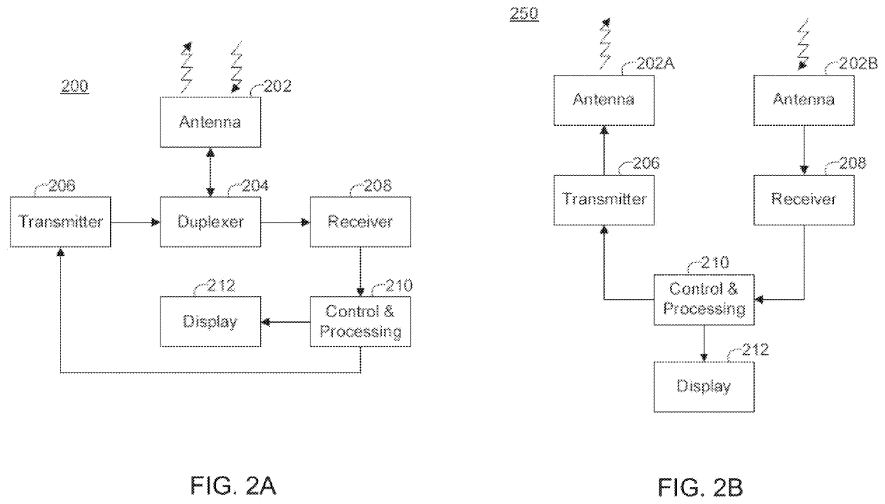

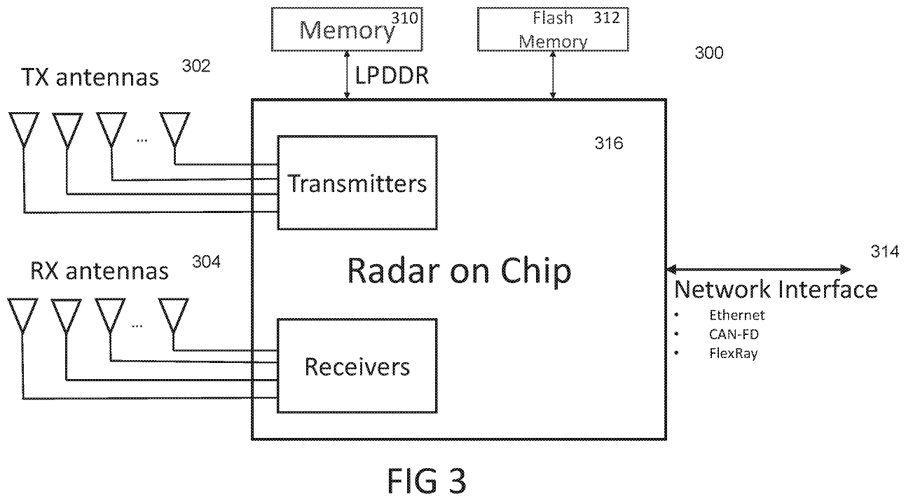

FIG. 2A illustrates an exemplary radar system 200 with an antenna 202 that is time-shared between a transmitter 206 and a receiver 208 via a duplexer 204. As also illustrated in FIG. 2A, output from the receiver 208 is received by a control and processing module 210 that processes the output from the receiver 208 to produce display data for the display 212. As discussed herein, the control and processing module 210 is also operable to produce a radar data output that is provided to other control units. The control and processing module 210 is also operable to control the transmitter 206. FIG. 2B illustrates an alternative exemplary radar system 250 with a pair of antennas 202a, 202b, a separate antenna 202a for the transmitter 206 and another antenna 202b for the receiver 208. While pulse radar systems may use shared or separate antennas, continuous wave radars (discussed herein) will use separate antennas (for transmitting and receiving) because of their continuous operation.

There are several types of signals used in radar systems. One type of radar signal is known as a frequency modulated continuous waveform (FMCW). In this type of system, the transmitter of the radar system sends a continuous signal in which the frequency of the signal varies across some range of frequencies. This is sometimes called a chirp radar system. At the receiver a matched filter can be used to process the received signal. The output of the matched filter is a so-called “pulse-compressed” signal with a pulse duration inversely proportional to the bandwidth used in the chirp signal. Mixing (multiplying) the reflected wave from a target with a replica of the transmitted signal results in a CW signal with a frequency that represents the distance between the radar transmitter/receiver and the target. By sweeping up in frequency and then down in frequency the Doppler frequency can also be determined.

The transmitted signal from each radar transmitter consists of a baseband signal which is upconverted to an RF signal by an RF upconverter followed by an antenna.

The received signal at each radar receiver antenna is downconverted by an RF downconverter to a complex baseband signal. The baseband transmitted radio signals and the reflected radio signals after downconversion in the receiver are provided to the processor. As an example, a baseband signal used for transmission might consist of repeated sequences of random or pseudo-random binary values for one transmitter, e.g., (−1, −1, −1, −1, 1, 1, 1, −1, 1, 1, −1, −1, 1, −1, 1), although any sequence, including non-binary sequences and non-periodic sequences could be used and different sequences would be used for different transmitters. The use of truly random number generators and pseudo random number generators to produce the values used to phase modulate the radio signal before transmission is described in detail in U.S. patent application Ser. No. 15/204,003, filed Jul. 7, 2016, which is hereby incorporated by reference herein in its entirety.

The exemplary radar sensing system may also utilize aspects of the radar systems described in U.S. provisional applications, Ser. No. 62/319,613, filed Apr. 7, 2016, Ser. No. 62/327,003, filed Apr. 25, 2016, Ser. No. 62/327,004, filed Apr. 25, 2016, Ser. No. 62/327,005, filed Apr. 25, 2016, Ser. No. 62/327,006, filed Apr. 25, 2016, Ser. No. 62/327,015, filed Apr. 25, 2016, Ser. No. 62/327,016, filed Apr. 25, 2016, Ser. No. 62/327,017, filed Apr. 25, 2016, Ser. No. 62/327,018, filed Apr. 25, 2016, Ser. No. 62/332,544, filed May 6, 2016, Ser. No. 62/336,966, filed May 16, 2016, Ser. No. 62/338,792, filed May 19, 2016, Ser. No. 62/816,941, filed Mar. 12, 2019, Ser. No. 63/167,347, filed Mar. 29, 2021, Ser. No. 63/140,567, filed Jan. 22, 2021, Ser. No. 63/194,267 filed May 28, 2021, which are all hereby incorporated by reference herein in their entireties.

### Radar System Range Walk Compensation:

Modern pulse radars achieve coherent integration by performing a Fast Fourier Transform (FFT) along the pulse repetition interval (PRI) time dimension. This FFT exploits the Doppler Effect introduced by moving targets along the line-of-sight of the radar. However, the conventional Doppler FFT approach simplifies actual physics of the moving targets. With actual physics of motion, in addition to Doppler rotation caused by radio frequency (RF) wave compression or expansion, the range of the moving target is also changing. This latter part of the actual physics is called target range walking, or range migration.

A conventional Keystone transformation technique requires a sophisticated processing chain in the radar receiver. That extra sophistication comes at a cost of joint processing of both range and Doppler dimensions.

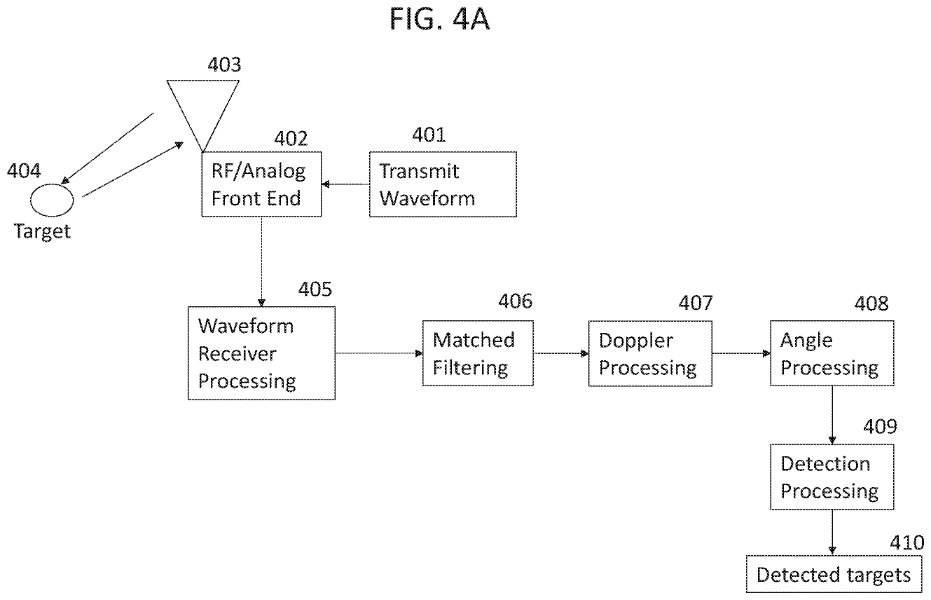

FIG. 4A illustrates an exemplary radar processing system. An exemplary transmit waveform 401 is generated for transmission via an RF/analog front end 402. The RF front end 402 includes the analog components needed to transmit the radar waveform at the radio frequency (RF) designed for radar. The RF front end 402 also forms an analog receiving path to process the radar reflections coming back from a target 404. An antenna array 403 is attached to the RF front end 402. The antenna array 403 interfaces the RF transmissions to the air (transmits the radio signals). The RF transmissions illuminate a target 404 that reflects some of the radar transmissions back to the radar system. The received radar reflection (at the antenna array 403) is routed by the RF front end 402 into a waveform receiver 405.

The waveform receiver 405 is configured to provide the waveform processing needed to convert down-converted signals into the original modulation as closely as possible. Following the waveform receiver 405 is a filter 406 providing matched filtering of the modulation. A Doppler processing module 407, is next, followed by an angle processing module 408 that exploits antenna array geometries. Lastly a detection module 409 is configured to perform target detection by estimating the noise floor and signals above that noise. At the output of the entire receiver processing chain is a list of detected targets 410, which can be used by radar applications.

FIG. 4B is a diagram of an exemplary radar receiver architecture for Range Walk Compensation (RWC) as an enhancement to the Doppler processing shown earlier. This architecture inserts a rotation process realized by mixer 423 and Doppler adjust 424, immediately following the ADC 422. The mixer 423 and Doppler adjust 424 can be configured with a known frequency, that's translated from the velocity of the radar, per duration of a radar scan. This pre-RWC frequency rotation is usually set to the Ego velocity of the radar and provided to the RWC block 426 such that the RWC block 426 can adjust all other Dopplers relative to this one.

When a radar implements multi-antennas, an exemplary range correlator 425 processes virtual receiver (VRX) outputs into the Doppler FFT & RWC 426. Each VRX corresponds a respective one of each transmitter and receiver of the multi-antenna system. Hence, the Doppler FFT & RWC 426 repeats its processing for each VRX in the system.

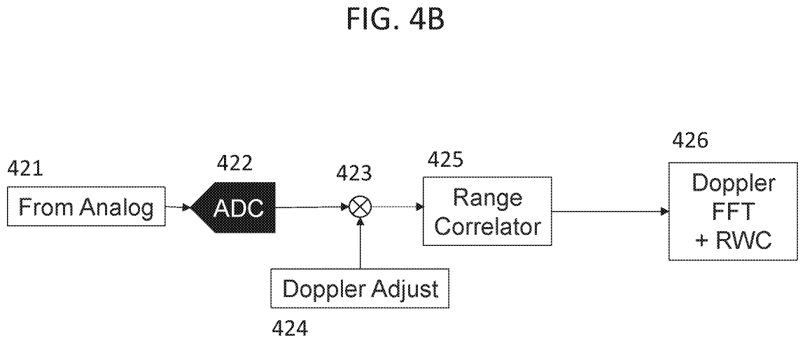

FIG. 5 illustrates additional details from the architecture of FIG. 4. A radar parameters block 505 retrieves all radar configurations related to RWC (range walk compensation). Some parameters belong to the part of the algorithm that processes Doppler groups which then has to be translated by a Doppler grouping block 506 such that data processing blocks from the range walk filter 502 to the range walk transforms 403 to the output data formatter 504 can operate correctly.

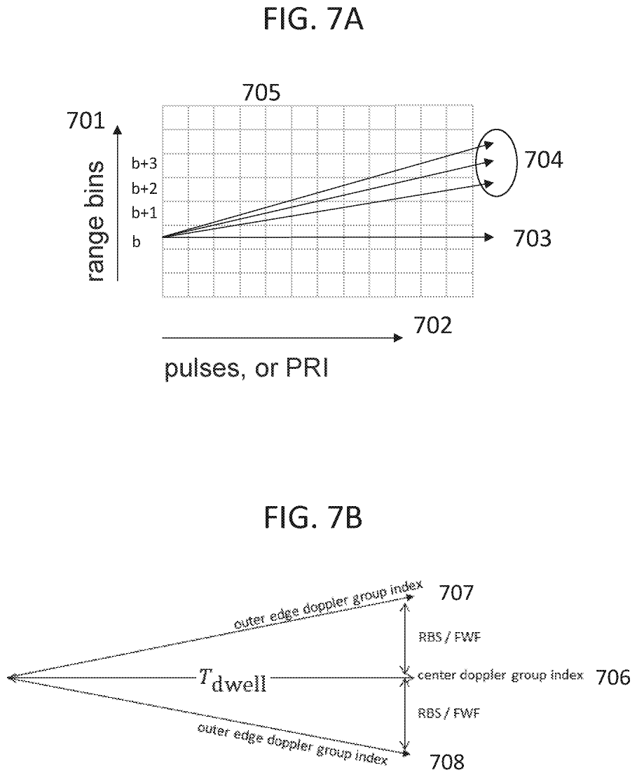

The range walk filter 502 has two configurations: a nearest bin, or a 2-tap filter. These parts of the exemplary embodiment will be explained later with respect to FIG. 8

The range walk transforms block 503 uses a conventional FFT engine as its core computational capability, except that the FFT engine is executed multiple times, and as many times as there are Doppler groups. This will also be elaborated further later on.

After the RWC FFT block 426 (see FIG. 4B), the output data formatter 504 formats the output frames into correct doppler bins such that the final output corresponds to a complete transform block. The entire block is complete when every doppler group has been processed.

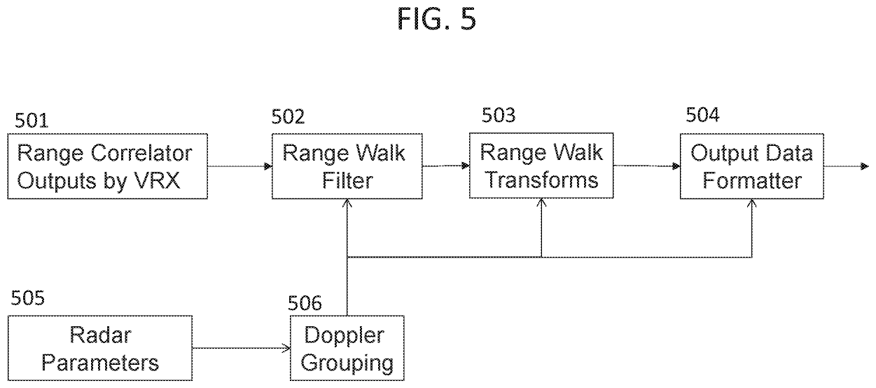

FIG. 6 illustrates an exemplary embodiment of the RWC algorithm's major processing steps. An exemplary loop control 601 steps through every range bin (RB) and processes its corresponding range walk transformation. An exemplary radar data cube (RDC) 602 includes arrays of data that have samples in the range bin, PRI, and VRX dimensions. This data, called RDC1, is fed into the RWC algorithm block 604. Block 605 is the output RDC2 data that have transformed the PRI time array samples from RDC1 602 to the Doppler frequency domain. The RDC2 603 contains the samples in the range bin, Doppler bin, and VRX dimensions.

Inside section 604, the FFT transforms are looped by control block 605 for all Doppler groups created previously by the setup process, for each RB processed. A first data processing block 606 filters the input data by either a nearest bin select or an N-tap filter. Next is a windowing block 607 which applies a conventional windowing technique of choice before FFT, which is performed on that data by a conventional FTT block 608. The FFT output is placed by an exemplary group index placement block 609 into the corresponding frequency bins based on the Doppler grouping setup. Finally, a range walk transform output block 610 is a data collection process that buffers each group of FFT output data until all groups are finished. After all the Dopplers are processed, the range walk transform output block 610 writes out the one RWC output frame of transformed data to RDC2 data set (603).

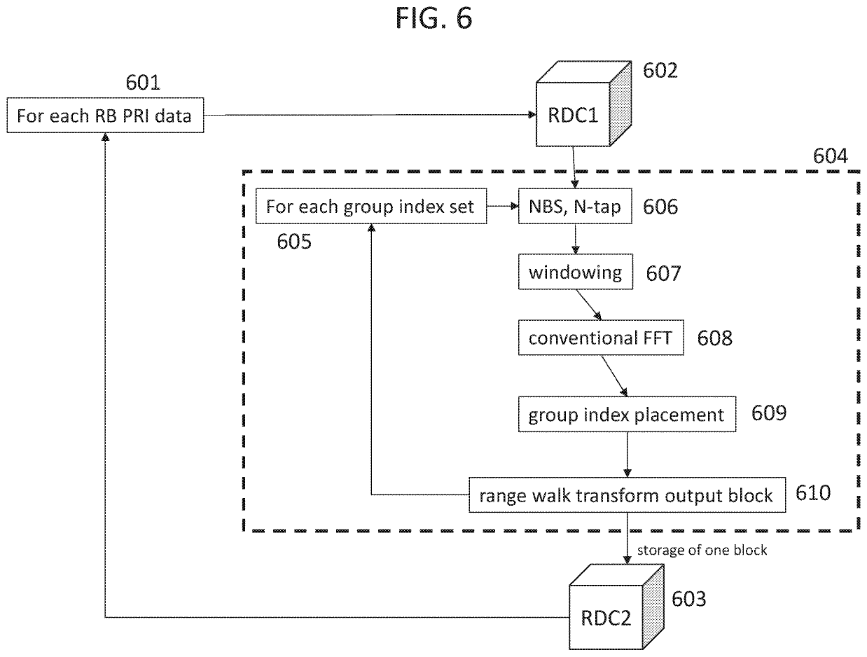

FIG. 7A illustrates an exemplary grouping of pulses for RWC FFT. Data from the correlator output is arranged into an array 705, per VRX. Along the vertical axis of this array 705 are range bin samples 701 with each row being labeled like b, b+1, b+2, and so on. The horizontal axis 702 of the array 705 are samples from pulses in each PRI. Conventional coherent integration along the PRI would need just one FFT per range bin, such as across the samples along the line labeled by 703.

But for targets that are moving sufficiently fast, such that their ranges are changing, the actual coherent integration would be reading samples along the diagonal lines labeled by 704. The lines 704 are a group of diagonal lines, each one representing a different Doppler frequency, or velocity, of target(s).

When the target is moving sufficiently fast such that its range is changing, the target's range bin location may increase with increasing PRI count. Then the actual Doppler transform would be reading samples along the diagonal lines 704. Each one of the diagonal lines 704 represents a different Doppler frequency, or velocity, of target(s). The center line in group 704 may be used as a close approximation to other lines.

These diagonal lines 704 along each Doppler with range walking are used to create Doppler groups for RWC. It's possible to assign one Doppler group per line for every Doppler from the collection of PRI's. In one exemplary embodiment, a selected quantity of Doppler lines are grouped to form one group and a center line of the group is selected as the FFT transformation line.

FIG. 7B illustrates an exemplary Doppler group that has been parameterized in relation to the configuration of the radar system. Specifically, the Doppler group is determined by the dwell time, the range bin size (RBS), and a unit-less parameter FWF, Fractional Walk Factor. FWF is configurable per dwell by the Radar Parameters (505). Given a chosen center Doppler line 701, the Doppler group is created by identifying the edge lines of that group. The upper edge 707 is bounded by positive velocity such that the distanced walked by the corresponding target over the dwell time is not more than RBS/FWF, and increases from the range bin at the start of the dwell.

Similarly for the lower boundary of the group 708, the negative Doppler serves the lower boundary for the group where the range bin doesn't decrease at the end of the dwell by more than RBS/FWF from the range bin at the start of the dwell.

FIG. 8 illustrates an exemplary implementation of the nearest bin select (NBS) method to read from the PRI samples. An exemplary location to read the samples follows the center line 801 of that group. With the start of that line in the middle of range bin b 803, after some number of PRI the line would cross into the range bin b+1. Before that crossing, the transformation input samples are read from range bin b (803). At the crossing point 802, the nearest bin select would direct the sample reading from range bin b+1. This strategy of reading from incrementing range bins continues for every cross over point for the entire dwell time.

To compute the PRI number where the crossing point occurs, calculate the velocity of the doppler line of interest. Suppose that Doppler line 801 has a corresponding frequency of f_{cd}, then its corresponding velocity is:

$${v}_{c d} = \frac{{f}_{c d} λ}{2}$$

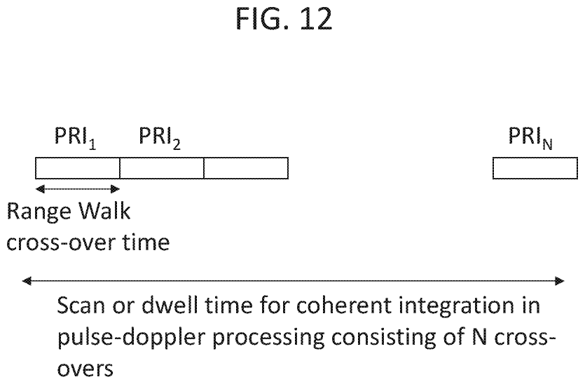

FIG. 12 illustrates an exemplary timeline of a radar scan that orders the range bin cross-over points in chronological order from left to right and labels them by PRI index. At PRI₁, the first cross over point occurs and this can be calculated as:

$${PRI}_{1} = \frac{RBS}{2 {v}_{c d} {T}_{p}} ,$$

where Tₚ is the PRI duration, and RBS is the range bin size.

Note that the PRI index is the range bin cross-over point measured by the PRI counts. It's not the PRI time duration as labeled by Tₚ.

Subsequent cross over points that occur at PRIₙ are defined by:

$${PRI}_{n} = {PRI}_{1} + \frac{RBS ( n - 1 )}{{v}_{c d} {T}_{p}} .$$

Besides the NBS technique illustrated in FIG. 6, the NBS, N-tap block 606 also includes a read and filter technique: N-tap filter. For practical purposes, the number of taps is usually 2 (“2-tap filter”). For the positive Doppler velocity, illustrated in FIG. 7B, the 2-tap filter output is calculated as follows:

$$y ( b , n ) = {c}_{0} ( n ) x ( b , n ) + {c}_{1} ( n ) x ( b + 1 , n ) ,$$

where b is the range bin that transform is to read from, n is the PRI index, c₀ and c₁ are the 2-tap filter coefficients that are functions of n, x is the read data samples from RDC1 (602).

Although 2-tap filter coefficients are functions of the autocorrelation shape of the radar waveform, a preferred method to calculate the coefficients is to use the sin(x)/x, or sinc(x) function.

Due to range walking, the b index starts at the range bin of interest and would increment at each cross over point 802.

$${c}_{0} = sin c ( π {d}_{0} ( n ) α ) ,$$

where α is a scaling to adjust the mainlobe width of the sinc( ), RBS is range bin size, and

$${d}_{0} ( n ) = mod ( \frac{( n - 1 ) {v}_{c d} {T}_{p}}{RBS} , 1.0 ) .$$

Then check if d₀(n)>0.5, set d₀(n)=1−d₀(n)

$${d}_{1} ( n ) = 0.5 - {d}_{0} ( n ) \\ {c}_{1} = sin c ( π {d}_{1} ( n ) α ) .$$

The preferred configuration for α=1.1.

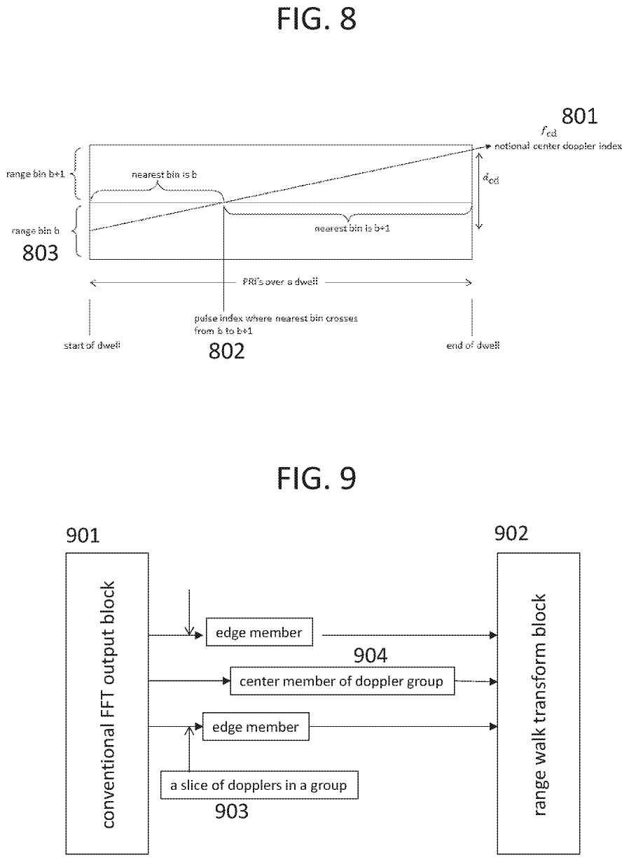

FIG. 9 illustrates an exemplary embodiment of the group index placement algorithm. The algorithm operates between the conventional FFT 901, and the output frame 902. For a given group, the frequency bin from the conventional FFT 901 is mapped one-to-one to the range walk output frame 902. This occurs for the special case when the Doppler adjust in the target 404 has zero-frequency. The number of conventional FFT output index that are mapped are those that are inside the grouping index as bounded by the slice of Dopplers in a group (903).

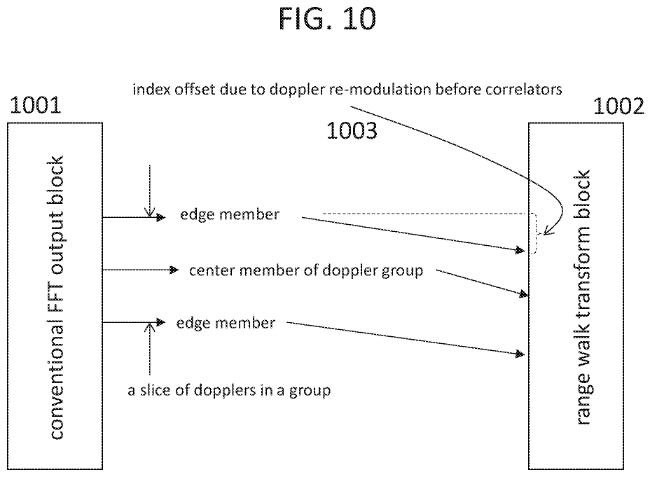

FIG. 10 illustrates an exemplary implementation of group index offset if the Doppler adjust in the target 404 (in FIG. 4A) is non-zero frequency. When the Doppler adjust is non-zero, each of the frequency bins from the conventional FFT are mapped to the range walk frame output by a fixed offset in accordance to the non-zero doppler frequency adjust.

The number of index to offset is given by:

$${k}_{offset} = {f}_{offset} {T}_{dwell} ,$$

where f_{offset} is the Doppler frequency adjustment used by the target 404.

In addition to the index offset, the corresponding velocity of the Doppler groups are also offset, given by:

$$v = \frac{( k - {k}_{offset} ) λ}{2 {T}_{dwell}} .$$

This new velocity that has been offset by the Doppler adjustment must be substitute back to the equations illustrated in FIGS. 7A and 7B to calculate the new cross over points to determine the input samples to the conventional FFT (1001).

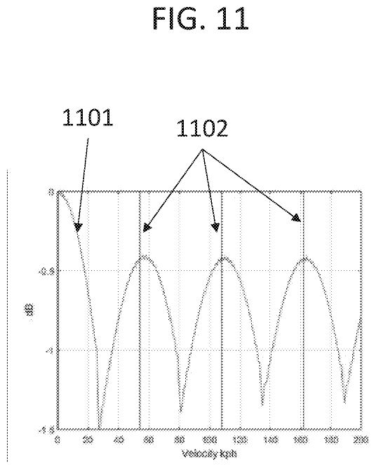

FIG. 11 illustrates a practical use of such Range Walk Compensation. The lines indicated by 1102 are the center Doppler frequencies where the Doppler groups are formed. The curve 1101 is the relative SNR loss against moving targets of different velocities, as compared to if no range walk actually occurred and a zero-doppler coherent integration was done. Curve 1101 shows bigger losses at the edge lines between the Doppler groups and less loss at the center of the groups.

Thus, the exemplary embodiments discussed herein include an exemplary radar system that provides for improving a coherent integration gain of the radar system when a target velocity is sufficiently high enough such that range bin migration can occur during a radar scan. By apply a prediction of the range bin migration for each target Doppler, the losses of signal power as a result of range bin migration can be compensated for. The exemplary techniques may also include the creation of Doppler groups where only a single Doppler frequency in that Doppler group (usually a middle one) is used as a prediction of range bin migration or range walking. By creating Doppler groups, the total complexity of Doppler processing with range walk compensation can be reduced in accordance with the number of Doppler groups to create.

Changes and modifications in the specifically described embodiments can be carried out without departing from the principles of the present invention, which is intended to be limited only by the scope of the appended claims, as interpreted according to the principles of patent law including the doctrine of equivalents.

1. A radar system comprising:
a first transmitter configured to transmit radio signals;
a first receiver configured to receive radio signals that include radio signals transmitted by the transmitter and reflected from objects in an environment;
wherein the first receiver is configured to perform a range walk compensation comprising performing a selected respective FFT for each of a plurality of groups of radar pulses in each of a plurality of range bins.

2. The radar system of claim 1, wherein the first receiver is configured to perform the range walk compensation by creating Doppler groups for each range bin, with one FFT executed per Doppler group using a selected Doppler of each respective Doppler group to predict the change in range bins, and wherein the receiver is configured to perform the range walk compensation on each range bin of the plurality of range bins to enhance coherent integration to reduce system loss.

3. The radar system of claim 2, wherein the selected Doppler of each respective Doppler group is a center group Doppler.

4. The radar system of claim 2, wherein the first receiver is configured to create a plurality of Doppler groups for each range bin coherent integration, wherein the plurality of Doppler groups is the plurality of groups of radar pulses, and wherein the first receiver is configured to perform a separate range walk compensation for each range bin of the plurality of range bins.

5. The radar system of claim 1, wherein the first receiver is configured to perform the range walk compensation by using a division factor, a fractional walk factor, to create a uniform group of Dopplers across the entire coverage of supported target velocities.

6. The radar system of claim 1, wherein the first receiver is configured to perform the range walk compensation using a nearest bin select or a 2-tap filter to filter the FFT input data as a predicted Doppler affects changes to range bins during a coherent integration time.

7. The radar system of claim 3, wherein the center group Doppler of a Doppler group is defined with respect to upper and lower Doppler boundaries of the Doppler group.

8. The radar system of claim 1 further comprising a plurality of transmitters configured to transmit radio signals and a plurality of receivers configured to receive radio signals that include radio signals transmitted by the transmitters and reflected from objects in the environment, wherein the plurality of transmitters comprises the first transmitter, and wherein at least one of the receivers of the plurality of receivers is configured to perform a range walk compensation, and wherein the at least one of the receivers comprises the first receiver.

9. The radar system of claim 1, wherein the receiver is configured to perform the range walk compensation by performing a Doppler adjustment of the received radio signals based upon the selected respective FFTs performed on the plurality of groups of radar pulses in each of the plurality of range bins.

10. The radar system of claim 8, wherein the Doppler adjustment comprises an initial Doppler adjustment defined by an own velocity such that subsequent Doppler adjustments are performed relative to the initial Doppler adjustment.

11. A method for controlling a radar system, the method including:
transmitting, with a plurality of transmitters, radio signals;
receiving, with a plurality of receivers, radio signals that include radio signals transmitted by the transmitters and reflected from objects in an environment; and
performing a range walk compensation by performing a selected respective FFT for each of a plurality of groups of radar pulses in each of a plurality of range bins.

12. The method of claim 11, wherein performing the range walk compensation comprises creating Doppler groups for each range bin, with one FFT executed per Doppler group using a selected Doppler of each respective Doppler group to predict the change in range bins, and wherein the range walk compensation is performed on each range bin of the plurality of range bins to enhance coherent integration to reduce system loss.

13. The method of claim 12, wherein the selected Doppler of each respective Doppler group is a center group Doppler.

14. The method of claim 11, wherein a plurality of Doppler groups are created for each range bin coherent integration, wherein the plurality of Doppler groups are the plurality of groups of radar pulses, and wherein a separate range walk compensation is performed for each range bin of the plurality of range bins.

15. The method of claim 11, wherein performing the range walk compensation comprises using a division factor, a fractional walk factor to create a uniform group of Dopplers across the entire coverage of supported target velocities.

16. The method of claim 11, wherein performing the range walk compensation comprises using a nearest bin select or a 2-tap filter to filter the FFT input data as the predicted Doppler affects changes to range bins during a coherent integration time.

17. The method of claim 13, wherein the center group Doppler of a Doppler group is defined with respect to upper and lower Doppler boundaries of the Doppler group.

18. The method of claim 11, wherein the range walk compensation is performed by at least one of the receivers of the plurality of receivers.

19. The method of claim 11, wherein the range walk compensation comprises a Doppler adjustment of the received radio signals based upon the selected respective FFTs performed on the plurality of groups of radar pulses in each of the plurality of range bins.

20. The method of claim 19, wherein the Doppler adjustment comprises an initial Doppler adjustment defined by an own velocity such that subsequent Doppler adjustments are performed relative to the initial Doppler adjustment.
